(19) United States
(12) Patent Application Publication
(10) Pub. No.: US 2004/0225646 A1
(43) Pub. Date: Nov. 11, 2004

(54) Numerical expression retrieving device

(76) Inventors: Miki Sasaki, Osaka (JP); Atsushi Ikeno, Kyoto (JP)

Correspondence Address: RABIN & Berdo, PC, 1101 14TH STREET, NW, SUITE 500, WASHINGTON, DC, 20005, US

(21) Appl. No.: 10/722,554

(22) Filed: Nov. 28, 2003

(30) Foreign Application Priority Data
Nov. 28, 2002 (JP) 345060/2002

(51) Int. Cl. G06F 7/00

(52) U.S. Cl. 707/3

(57) ABSTRACT

In order to realize a numerical expression retrieving device which permits a user to retrieve a numerical expression without caring about a case where the numerical expression is shortened to a prefix only, the numerical expression retrieving device of the present invention comprises input means for inputting any document to-be-retrieved or any numerical expression to-be-retrieved; syntactic parsing means for parsing the syntactic structure of the inputted document or numerical expression; an attribute dictionary which stores attribute information and unit system information therein, the attribute information including attribute names indicative of attributes, attribute contents indicative of the meanings of the attributes, and basic units for supplementing omitted representations, the unit system information including prefixes for deciding the incomplete or shortened numerical expressions, and multiples indicative of the meanings of the prefixes; a co-occurrence word dictionary which stores therein information including attribute names indicative of attributes, and co-occurrence words for deciding the attribute names; and omission completion means for supplementing the basic unit to the prefix of the inputted document or numerical expression by referring to the parsed syntactic structure and the attribute dictionary or by further referring to the co-occurrence word dictionary, thereby to complete the incomplete or shortened numerical expression.

### FIELD OF THE INVENTION

The present invention relates to a numerical expression retrieving device which retrieves a numerical expression in a natural language.

### BACKGROUND OF THE INVENTION

Numerical expressions which are variously represented in a natural language, but which have substantially the same meaning need to be converted so as to become retrievable.

With a prior-art numerical expression retrieving device stated in, for example, JP-A-5-67137, numerical expressions are searched for in a document and are submitted to the operations of matching with numerical expression templates, whereby the numerical expressions in the document can be collectively converted into appropriate numerical expressions. The retrieving device can be utilized for a machine translation system, etc.

With the prior-art numerical expression retrieving device, however, the numerical expressions are merely converted using the semantic information of words and conversion functions, so that any incomplete or shortened expression for which a plurality of meanings are considered cannot be correctly coped with.

By way of example, it is explained in the prior art that a “shaku” which is an old-time unit of length in Japan (one “shaku” is nearly equal to one foot) can be converted into “centimeter” when the “shaku” is previously registered as the numerical expression of length in the Japanese language, while the “centimeter” is previously registered as the numerical expression of length in the English language. However, in a case where a shortened word “kilo” appears in the document, it cannot be correctly converted because whether it indicates “kilometer” or “kilogram” cannot be judged.

The present invention has been made in view of such a problem of the prior-art retrieving device, and has for its object to provide a numerical expression retrieving device which can retrieve numerical expressions without caring about cases where they are shortened to prefixes only.

### SUMMARY OF THE INVENTION

In order to solve the problem, the numerical expression retrieving device of the present invention comprises input means for inputting any document to-be-retrieved or any numerical expression to-be-retrieved; syntactic parsing means for parsing a syntactic structure of the inputted document or numerical expression; an attribute dictionary which stores attribute information and unit system information therein, the attribute information including attribute names indicative of attributes, attribute contents indicative of meanings of the attributes, and basic units for supplementing omitted representations, the unit system information including prefixes for deciding omissions, and multiples indicative of meanings of the prefixes; a co-occurrence word dictionary which stores therein information including attribute names indicative of attributes, and co-occurrence words for deciding the attribute names; and omission completion means for supplementing a basic unit to a prefix of the inputted document or numerical expression by referring to the parsed syntactic structure and the attribute dictionary, or by further referring to the co-occurrence word dictionary, thereby to complete the incomplete numerical expression.

### BRIEF DESCRIPTION OF THE DRAWINGS

FIG. 1 is a block arrangement diagram of a numerical expression retrieving device in an embodiment of the present invention;

FIG. 2 is a diagram showing parsed examples of the syntactic structures of Japanese sentences each of which contains a numerical expression;

FIG. 3 is a diagram showing a constructional example of an attribute dictionary in FIG. 1;

FIG. 4 is a diagram showing a constructional example of a co-occurrence word dictionary in FIG. 1;

FIG. 5 is a flow chart for explaining the operation of the numerical expression retrieving device in FIG. 1;

FIG. 6 is a flow chart for explaining the operation of a submission process at a step 502 in FIG. 5;

FIG. 7 is a diagram showing parsed examples of syntactic structures at a step 602 in FIG. 6; and

FIG. 8 is a flow chart for explaining the operation of a retrieval process at a step 503 in FIG. 5.

### DETAILED DESCRIPTION OF THE PREFERRED EMBODIMENTS OF THE INVENTION

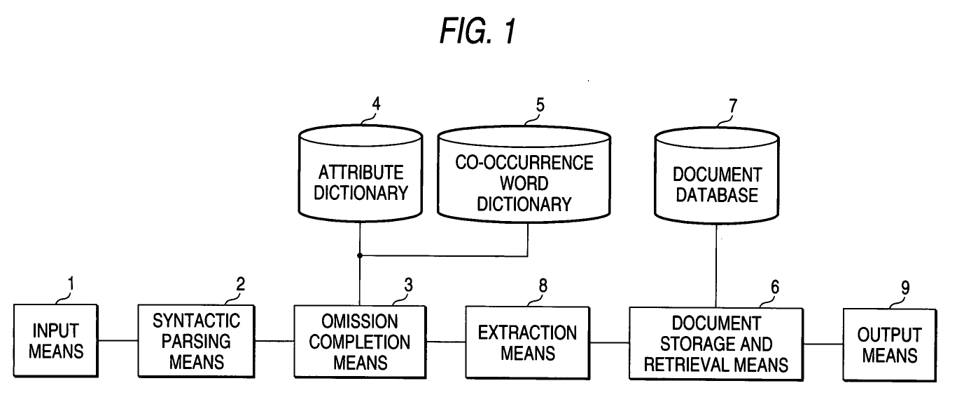

FIG. 1 is a block arrangement diagram of a numerical expression retrieving device in an embodiment of the present invention. The numerical expression retrieving device of this embodiment includes input means 1, syntactic parsing means 2, omission completion or supplementation means 3, an attribute dictionary 4, a co-occurrence word dictionary 5, document storage and retrieval means 6, a document database 7, extraction means 8, and output means 9.

The input means 1 is means for inputting a document to-be-retrieved or a numerical expression to-be-retrieved. This input means 1 sends the inputted document or numerical expression to the syntactic parsing means 2.

The syntactic parsing means 2 is means for parsing the structure of the inputted sentence. This syntactic parsing means 2 parses the syntactic structure of the document or numerical expression sent from the input means 1 by a morphological analysis and a syntactic analysis, and it sends the parsed syntactic structure to the omission completion means 3 together with the inputted original document or numerical expression.

The omission completion means 3 is means for supplementing a basic unit to any numerical expression which is shortened to a prefix only (: which is shortened and as which only a prefix is stated). This omission completion means 3 supplements the basic unit to the prefix of the document or numerical expression on the basis of the syntactic structure sent from the syntactic parsing means 2, and with reference to the attribute dictionary 4 as well as the co-occurrence word dictionary 5, and it sends the completed or supplemented document or numerical expression to the extraction means 8 together with the inputted original document or numerical expression.

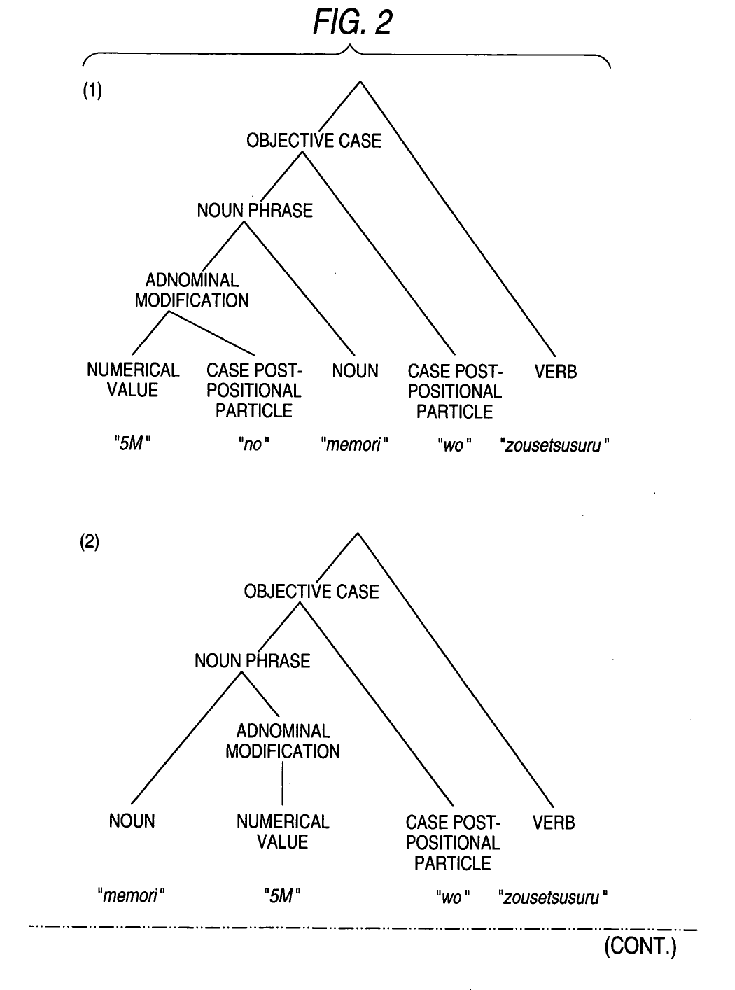

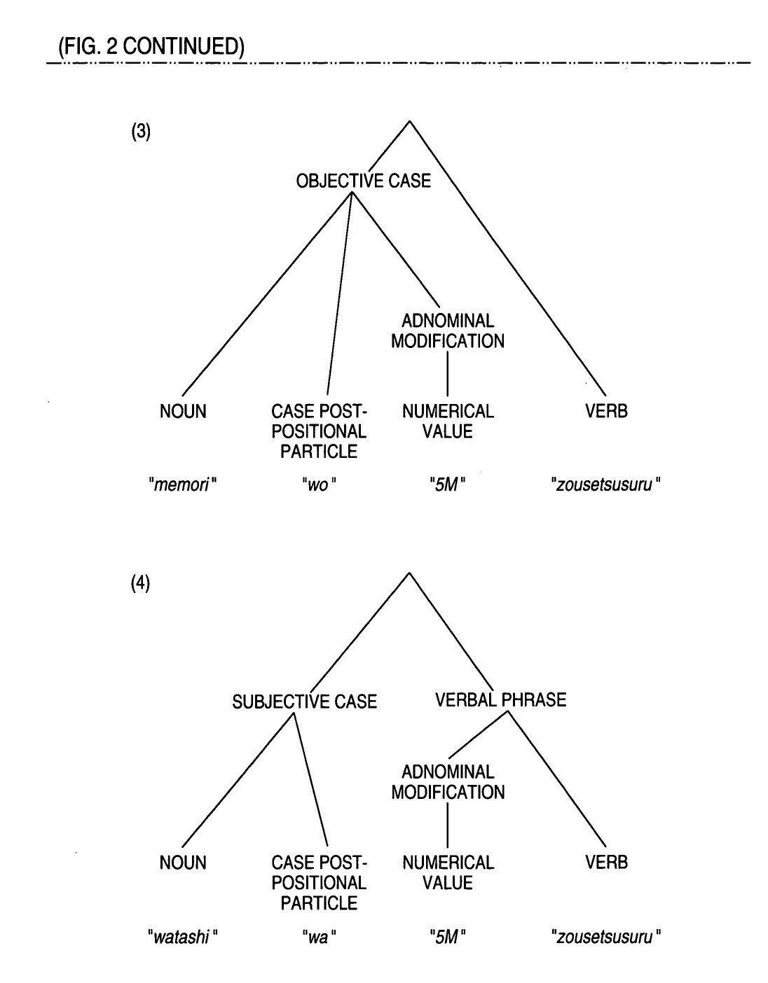

FIG. 2 is a diagram showing parsed examples of the syntactic structures of sentences each of which contains a numerical expression. Incidentally, the examples elucidate processing for a document in Japanese. In case of English translation, both the Japanese document or sentence and an English document or sentence aligned therewith are stated as may be needed.

A word to be modified by the numerical expression is set as the co-occurrence word of this numerical expression. The co-occurrence word of the numerical expression “5M” at (1), (2) or (3) in FIG. 2 becomes “memory”. Besides, the co-occurrence word of the numerical expression “5M” at (4) in FIG. 2 becomes “expand”.

The attribute dictionary 4 is a dictionary for storing the information of attributes and the information of unit systems therein. In the attribute dictionary 4, the attribute information consists of attribute names, attribute contents and basic units, while the unit system information consists of prefixes, multiples and basic units.

The co-occurrence word dictionary 5 is a dictionary for storing therein the information of co-occurrence words which complete or compensate for omissions. This co-occurrence word dictionary 5 consists of attribute names and the co-occurrence words.

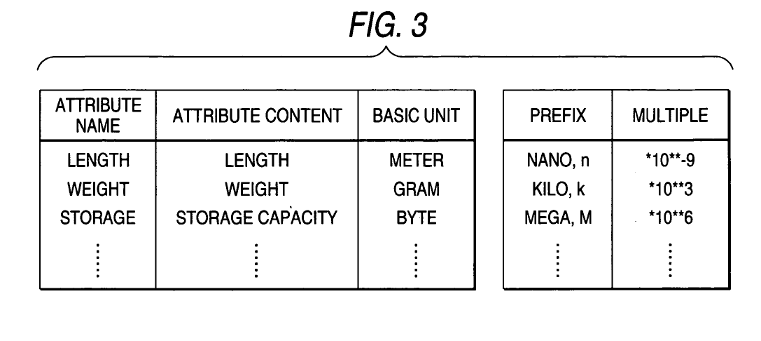

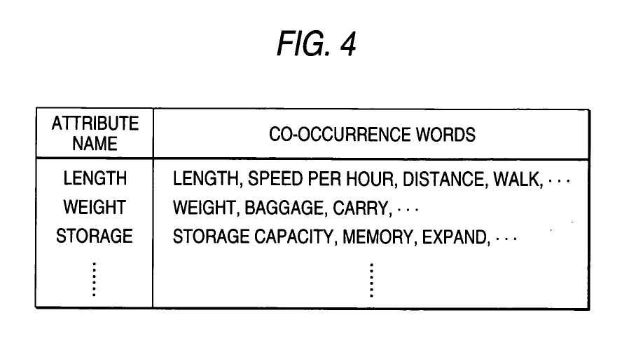

FIG. 3 is a diagram showing a constructional example of the attribute dictionary 4, while FIG. 4 is a diagram showing a constructional example of the co-occurrence word dictionary 5.

The document storage and retrieval means 6 is means for storing and retrieving documents. This document storage and retrieval means 6 stores the completed document, the original document and a retrieval keyword inputted from the extraction means 8, in the document database 7, and it retrieves any document whose retrieval keyword agrees with the completed numerical expression inputted from the extraction means 8, from the document database 7, so as to send the retrieved document to the output means 9.

The document database 7 is a database in which documents to be retrieved and completed documents are stored.

The extraction means 8 is means for extracting retrieval keywords. This extraction means 8 sends the document storage and retrieval means 6 the completed document and numerical expression which have been inputted from the omission completion means 3, and the retrieval keyword as which the completed word has been extracted.

The output means 9 is means for outputting a result. This output means 9 outputs the retrieved result sent from the document storage and retrieval means 6.

Incidentally, a process for making the morphological analysis, a process for making the syntactic analysis, a process for databasing documents, a process for storing or retrieving documents, and a process for extracting the pertinent part (: retrieval keyword) can be executed with known natural language processing technologies as regards general parts.

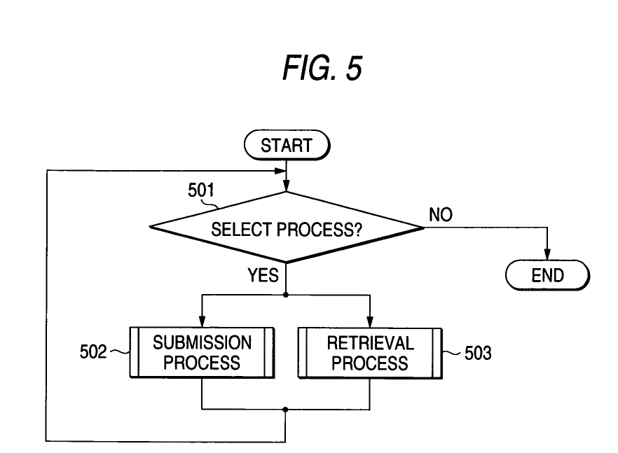

FIG. 5 is a flow chart for explaining the operation of the numerical expression retrieving device in the embodiment of the present invention. Referring to FIG. 5, a process is selected by the input means 1 (step 501) so as to execute the submission process (step 502), to execute the retrieval process (step 503), or to end the routine.

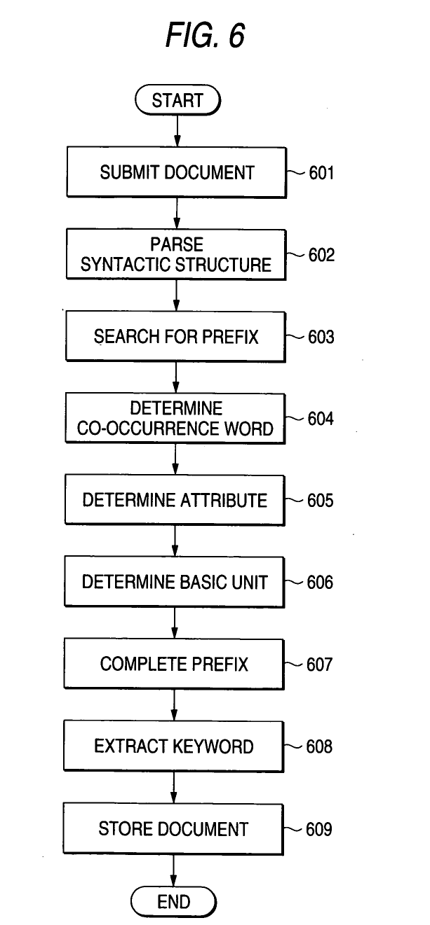

FIG. 6 is a flow chart for explaining the operation of the submission process at the step 502 in FIG. 5.

In the submission process in FIG. 6, a document to be retrieved is first submitted to the input means 1 (step 601).

By way of example, the following illustrative sentence (a) or (b) is submitted:

“Walked carrying baggage of 10 kilo” (a)

“Walked 10 kilo, carrying baggage” (b)

The document submitted to the input means 1 is sent to the document parsing means 2.

Subsequently, the syntactic structure of the submitted document is parsed in the syntactic parsing means 2 (step 602).

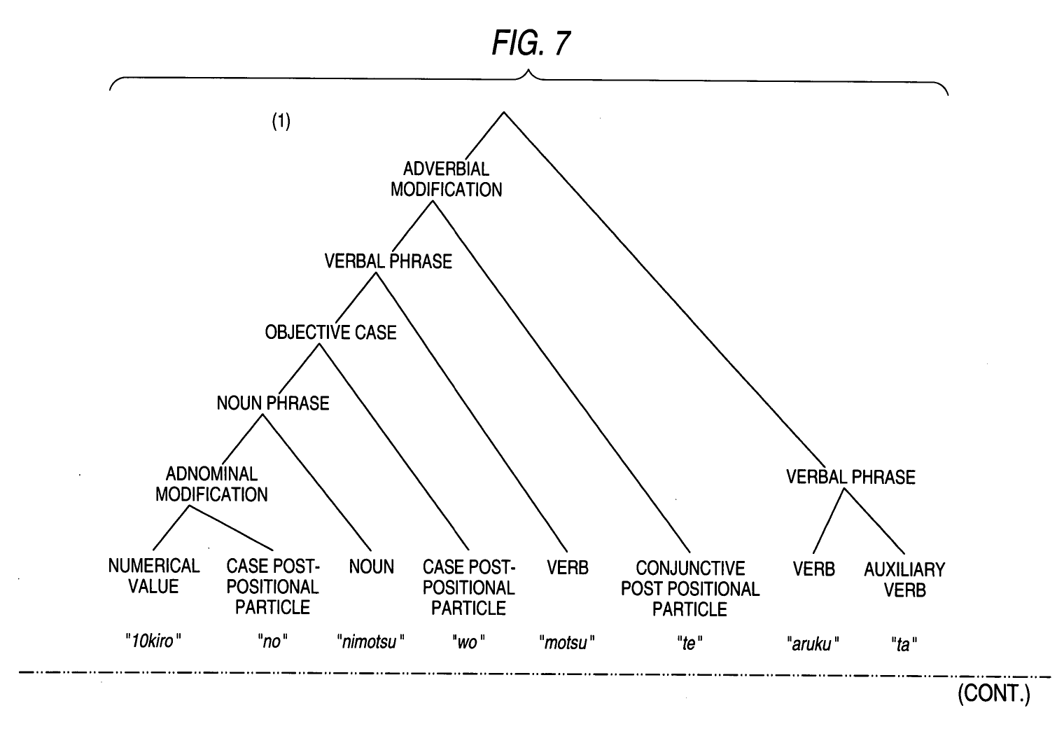

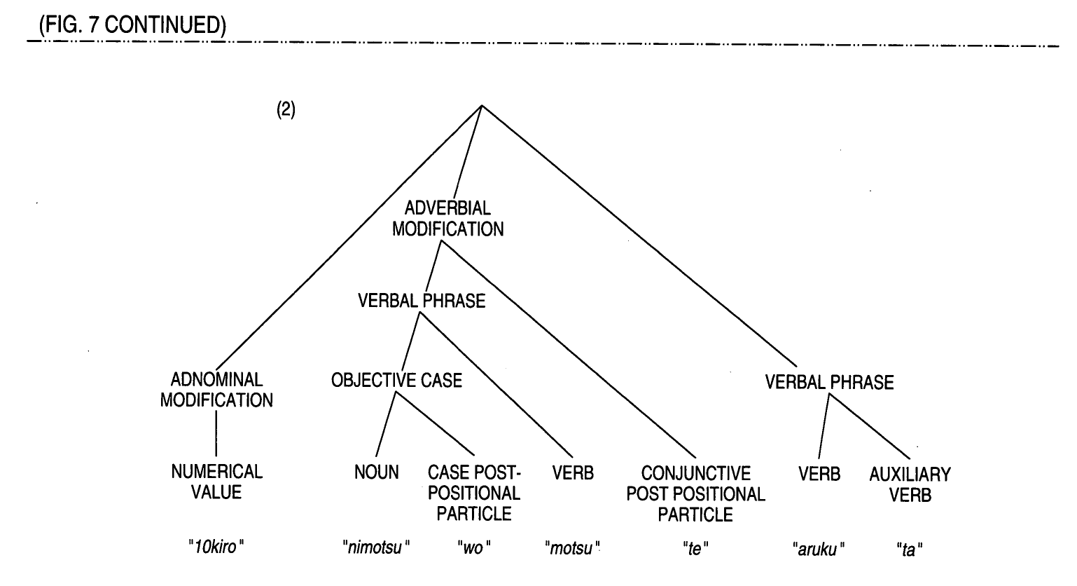

(1) and (2) in FIG. 7 show parsed examples of the syntactic structures of the respective illustrative sentences (a) and (b).

The syntactic structure after the parsing in the syntactic parsing means 2 is sent to the omission completion means 3 together with the original document sent from the input means 1.

Subsequently, in the omission completion means 3, any prefix is searched for from the document with reference to the parsed syntactic structure and the unit system information of the attribute dictionary 4 (refer to FIG. 3 as to the construction thereof) (step 603).

In both the illustrative sentences (a) and (b), “kilo” is searched for as the prefix.

Incidentally, processes from the step 603 through a step 607 below are executed in the omission completion means 3.

Subsequently, any co-occurrence word is determined from the syntactic structure parsed by the syntactic parsing means 2 (step 604).

The co-occurrence word in the illustrative sentence (a) is determined as “baggage”.

The co-occurrence word in the illustrative sentence (b) is determined as “walk”.

Subsequently, an attribute (: attribute name) is determined with reference to the co-occurrence word dictionary 5 (refer to FIG. 4 as to the construction thereof) (step 605).

The attribute name in the illustrative sentence (a) is determined as “WEIGHT”.

The attribute name in the illustrative sentence (b) is determined as “LENGTH”.

Further, a basic unit is determined with reference to the attribute dictionary 4 (step 606).

In the illustrative sentence (a), since the attribute is “WEIGHT”, the basic unit is determined as “gram”.

In the illustrative sentence (b), since the attribute is “LENGTH”, the basic unit is determined as “meter”.

Besides, the prefix is completed with the basic unit (step 607).

In the illustrative sentence (a), the prefix “kilo” is completed with the basic unit “gram”. Consequently, the sentence becomes “Walked carrying baggage of 10 kilogram(s)”.

In the illustrative sentence (b), the prefix “kilo” is completed with the basic unit “meter”. Consequently, the sentence becomes “Walked 10 kilometer(s), carrying baggage”.

The document after the completion is sent to the extraction means 8 together with the original document.

Subsequently, in the extraction means 8, the completed word is extracted as a retrieval keyword (step 608).

In the illustrative sentence (a), the word “10 kilogram(s)” is extracted as the keyword.

In the illustrative sentence (b), the word “10 kilometer(s)” is extracted as the keyword.

The extracted keyword is sent to the document storage and retrieval means 6 together with the original document.

Lastly, the original document and the retrieval keyword are stored in the document database 7 by the document storage and retrieval means 6 (step 609), whereupon the submission process is ended.

Regarding the illustrative sentence (a), the original document “Walked carrying baggage of 10 kilo” and the keyword “10 kilogram(s)” are stored in the document database 7.

Regarding the illustrative sentence (b), the original document “Walked 10 kilo, carrying baggage” and the keyword “10 kilometer(s)” are stored in the document database 7.

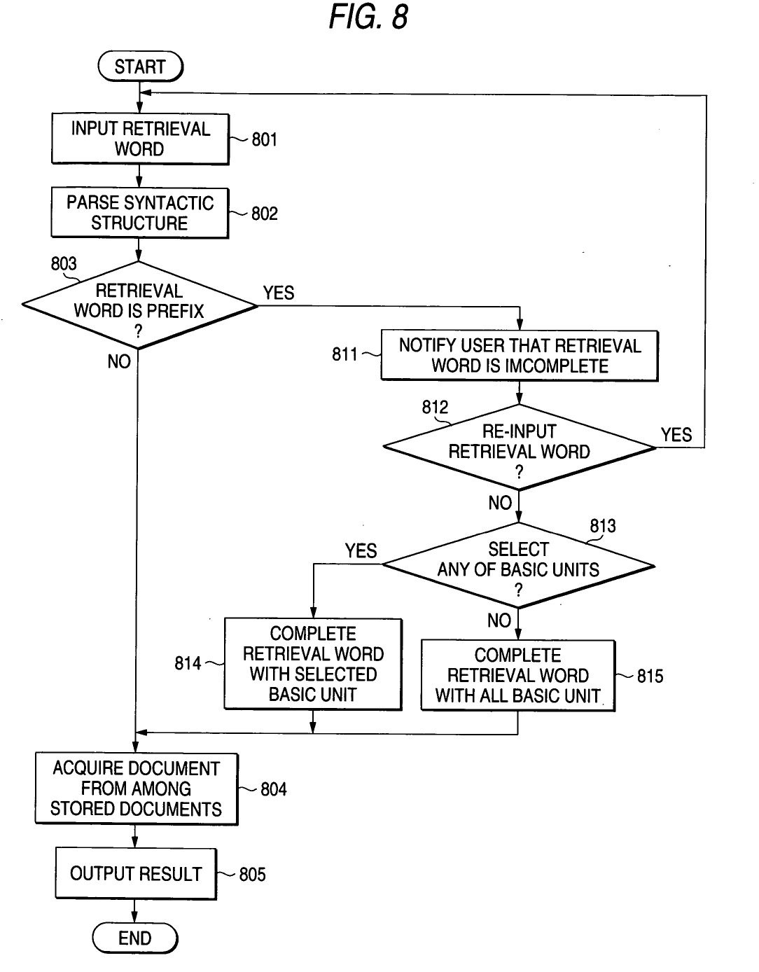

FIG. 8 is a flow chart for explaining the operation of the retrieval process at the step 503 in FIG. 5.

In the retrieval process in FIG. 8, a numerical expression to be retrieved is first inputted as a retrieval word to the input means 1 (step 801).

By way of example, the following illustrative sentence (c) or (d) is inputted as the retrieval word:

“10 kilometer(s)” (c)

“10 kilo” (d)

The numerical expression (: retrieval word) inputted to the input means 1 is sent to the syntactic parsing means 2.

Subsequently, the syntactic structure of the retrieval word is parsed in the syntactic parsing means 2 (step 802). The syntactic structure after the parsing in the syntactic parsing means 2 is sent to the omission completion means 3 together with the numerical expression (: retrieval word) sent from the input means 1.

Subsequently, in the omission completion means 3, whether or not the retrieval word is a prefix (whether or not the retrieval word is a numerical expression omitted or shortened to a prefix only) is decided with reference to the parsed syntactic structure and the unit system information of the attribute dictionary 4 (step 803).

In the illustrative sentence (c), the retrieval word is decided not to be the prefix.

In the illustrative sentence (d), a part “kilo” is decided to be the prefix.

In the case where the retrieval word has been decided not to be the prefix, at the step 803, it is sent to the document storage and retrieval means 6.

In this case, any document whose retrieval keyword agrees with the retrieval word is retrieved and acquired from documents stored in the document database 7, by the document storage and retrieval means 6 (step 804).

Regarding the illustrative sentence (c), the illustrative sentence (b), “Walked 10 kilo, carrying baggage” whose retrieval keyword is “10 kilometer(s)” is retrieved and acquired from the document database 7.

Besides, the document acquired at the step 804 is outputted as a retrieved result from the output means 9 (step 805).

That is, regarding the illustrative sentence (c), the illustrative sentence (b), “Walked 10 kilo, carrying baggage” is outputted as the retrieved result.

Meanwhile, in the case where the retrieval word has been decided to be the prefix, at the step 803, the lists of basic units and attribute contents are displayed on the output means 9 by referring to the attribute information of the attribute dictionary 4 in the omission completion means 3, thereby to notify the user of the retrieving device that the retrieval word is an incomplete or shortened numerical expression (step 811).

Incidentally, processes from the step 811 through a step 815 below are executed in the omission completion means 3.

Besides, whether or not the user re-inputs a retrieval word is inquired by presenting a display to that effect on the output means 9 (step 812).

In a case where the user has selected not to re-input the retrieval word, at the step 812, whether or not the user selects any of the basic units is inquired by presenting a display to that effect on the output means 9 (step 813).

In a case where any of the basic units has been selected at the step 813, the prefix (: retrieval word) is completed or supplemented with the selected basic unit (step 814).

Regarding the illustrative sentence (d), a basic unit “gram” is selected by way of example, and the retrieval word “10 kilo” is completed with the basic unit “gram”. Consequently, the retrieval word “10 kilo” becomes “10 kilogram(s)”.

The completed retrieval word is sent to the document storage and retrieval means 6.

Besides, in the case where the retrieval word has been completed at the step 814, any document whose retrieval keyword agrees with the retrieval word is retrieved and acquired from among the documents stored in the document database 7, by the document storage and retrieval means 6 (step 804), and the acquired document is outputted as a retrieved result from the output means 9 (step 805).

Regarding the illustrative sentence (d), the illustrative sentence (a), “Walked carrying baggage of 10 kilo” whose retrieval keyword is “10 kilogram(s)” is retrieved and acquired from the document database 7, and the acquired document is outputted as the retrieved result from the output means 9.

Meanwhile, in a case where any of the basic units has not been selected at the step 813, the prefix (: retrieval word) is completed with all the basic units (step 815).

Regarding the illustrative sentence (d), the retrieval word “10 kilo” is completed with all the basic units “meter”, “gram”, “byte”, by way of example, and retrieval words “10 kilo” becomes “10 kilometer(s)”, “10 kilogram(s)”, “10 kilobyte(s)”, . . . are obtained.

The retrieval words completed with all the basic units are sent to the document storage and retrieval means 6.

Besides, in the case where the inputted retrieval word has been completed at the retrieval step 815, documents whose converted retrieval keywords agree with all the completed retrieval words are respectively retrieved and acquired from the documents stored in the document database 7, by the document storage and retrieval means 6 (step 804), and the acquired documents are outputted as retrieved results from the output means 9 (step 805).

Regarding the illustrative sentence (d), illustrative sentences such as the illustrative sentence (a), “Walked carrying baggage of 10 kilo” whose retrieval keyword is “10 kilogram(s)”, and the illustrative sentence (b), “Walked 10 kilo, carrying baggage” whose retrieval keyword is “10 kilometer(s)”, are retrieved and acquired from the document database 7, and they are outputted as the retrieved results from the output means 9.

There are already existent a method which extracts words having modificative relations or casal relations, as co-occurrence words, a technique which creates a thesaurus indicative of the relations of extracted words, and a technique which translates separately on the basis of the relations of extracted words. However, the techniques handle modified words, casal nouns and verbs, and the attributes of numerical expressions to serve as modifying words cannot be determined even with the techniques.

As described above, according to the embodiment of the present invention, co-occurrence words are determined by parsing syntactic structures, and incomplete or shortened numerical expressions are completed and then stored beforehand, or only words which appropriately complete incomplete numerical expressions are provided at the time of retrieval, whereupon a document is retrieved. Thus, no matter which of the document to be retrieved and a retrieval word the incomplete numerical expression exists in, a numerical expression retrieving device automatically completes the incomplete numerical expression or compensates for the omitted representation thereof in order to perform the retrieval. Therefore, a user can perform the retrieval without caring about the omitted representation.

Besides, when the numerical expression retrieving device is applied to retrieval in a natural language, the retrieval of any numerical expression is facilitated.

Incidentally, although the numerical expression retrieving device in which only numerical expressions based on numerical values and units are subjects for retrieval or retrieval words has been described in the embodiment, the present invention can also be utilized in combination with a retrieving method or device in which other numerical expressions or non-numerical expressions are subjects for retrieval or retrieval words.

Moreover, in the embodiment, the details of processing have been described using illustrative sentences in the Japanese language, but the present invention is applicable even to a language other than Japanese, for example, the English or Chinese language.

Furthermore, in the embodiment, “meter” and “gram” which are units commonly used in Japan have been adopted as basic units which are stored in an attribute dictionary, but “foot” and “pound” which are units commonly used in U.S., etc. can also be adopted as basic units.

As thus far described, the present invention can bring forth the advantage that a user can perform retrieval by completing or supplementing any incomplete numerical expression shortened to a prefix only, without caring about the omitted representation thereof.

What is claimed is:

1. A numerical expression retrieving device for retrieving a numerical expression in a natural language, comprising:
input means for inputting any document to-be-retrieved or any numerical expression to-be-retrieved;
syntactic parsing means for parsing a syntactic structure of the inputted document or numerical expression;
an attribute dictionary which stores attribute information and unit system information therein, the attribute information including attribute names indicative of attributes, attribute contents indicative of meanings of the attributes, and basic units for supplementing omitted representations, the unit system information including prefixes for deciding omissions, and multiples indicative of meanings of the prefixes;
a co-occurrence word dictionary which stores therein information including attribute names indicative of attributes, and co-occurrence words for deciding the attribute names; and
omission completion means for supplementing a basic unit to a prefix of the inputted document or numerical expression by referring to the parsed syntactic structure and said attribute dictionary, or by further referring to said co-occurrence word dictionary, thereby to complete the incomplete numerical expression.

2. A numerical expression retrieving device according to claim 1, further comprising:
extraction means for extracting a word with the basic unit supplemented to the prefix, as a retrieval keyword from the document after the completion;
a document database which stores document data therein; and
document storage and retrieval means for storing the completed document, the inputted original document, and the extracted retrieval keyword in the document database;
wherein said omission completion means searches for a numerical expression shortened to a prefix only, from within the inputted document by referring to the parsed syntactic structure and said co-occurrence word dictionary, determines a co-occurrence word of the prefix on the basis of the parsed syntactic structure for the shortened numerical expression, determines an attribute name of the prefix by referring to said co-occurrence word dictionary on the basis of the determined co-occurrence word, and supplements the basic unit to the prefix by referring to said attribute dictionary on the basis of the determined attribute name.

3. A numerical expression retrieving device according to claim 2, further comprising:
output means;
wherein said omission completion means decides whether or not the inputted numerical expression is a numerical expression shortened to a prefix only, by referring to the parsed syntactic structure and said co-occurrence word dictionary, and in case of the numerical expression shortened to the prefix only, it notifies a user to that effect by said output means and thereby prompts him/her to re-input a numerical expression.

4. A numerical expression retrieving device according to claim 2, further comprising:
output means;
wherein said omission completion means decides whether or not the inputted numerical expression is a numerical expression shortened to a prefix only, by referring to the parsed syntactic structure and said co-occurrence word dictionary, and in case of the numerical expression shortened to the prefix only, it presents basic units and attribute information by said output means and thereby prompts a user to select one of the basic units, and it completes the shortened numerical expression with the selected basic unit.

5. A numerical expression retrieving device according to claim 4, wherein when the basic unit for completing the shortened numerical expression has not been selected, said omission completion means completes the shortened numerical expression with all basic units which can be supplemented.

6. A numerical expression retrieving device according to claim 3, wherein said document storage and retrieval means retrieves a document whose retrieval keyword agrees with the inputted numerical expression, from said document database, and it outputs the document as a retrieved result by said output means.
